(19) United States
(12) Patent Application Publication
(10) Pub. No.: US 2010/0153181 A1
(43) Pub. Date: Jun. 17, 2010

(54) SYSTEMS AND METHODS FOR PROVIDING INFORMATION SERVICES

(75) Inventors: Yucel Altunbasak, Johns Creek, GA (US); Faramarz Fekri, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Georgia Tech Research Corporation, Atlanta, GA (US)

(21) Appl. No.: 12/431,535

(22) Filed: Apr. 28, 2009

Related U.S. Application Data
(60) Provisional application No. 61/121,780, filed on Dec. 11, 2008.

(51) Int. Cl. G06Q 99/00; G06Q 10/00; G06Q 30/00; G06Q 20/00

(52) U.S. Cl. 705/10; 705/26; 705/40; 705/80; 705/347

(57) ABSTRACT

Systems and methods for providing information services are disclosed. A method for providing an information service can comprise providing a pool of providers, and receiving a request from a requester for an information service from at least one of the providers. One or more of the providers can be identified as a provider subset available to deliver the information service to the requestor. The identified provider subset can be presented to the requester, along with a reputation index for each provider in the provider subset. A selection of a first provider belonging to the provider subset can be received from the requestor. The information service can be performed by transmitting data from the provider to the requester in real-time.

### CROSS-REFERENCE TO RELATED APPLICATIONS

This application claims a benefit, under 35 U.S.C. §119(e), of U.S. Provisional Application Ser. No. 61/121,780, filed 11 Dec. 2008, the entire contents and substance of which are hereby incorporated by reference.

### BACKGROUND

1. Technical Field

Various embodiments of the present invention relate to information services and, more particularly, to systems and methods for providing information services in an online environment.

2. Description of Related Art

Various systems exist for enabling information exchange between individuals, but the current systems lack several benefits of embodiments of the present invention. Conventional information service systems fail to enable users to interact in real-time in a virtual environment capable of streaming media.

For example, in current education-focused information service systems, students can find tutors online. In these correct systems, however, a student and a tutor may have to arrange a mutually agreeable time to meet in person. Alternatively, if the student and tutor opt to interact over a network, they are generally limited in their communication media by uncontrollable characteristics of the network. Further, in conventional systems, the tutor is employed by a system operator for a purpose of providing such services to students. The student likely has little choice as to which tutor he is assigned and may have no choice in the cost or quality of the tutor's services.

For another example, some information service systems enable a user to ask a question for others to view and answer. When others access the system, they can view and answer the question. When the user returns to the system, he or she can view received answers. If the user requires further information or clarification, the user has to pose another question and await another set of answers. Because such an environment does not enable real-time communications, the user may have to endure many iterations of questioning and answering before receiving all required information.

In contrast to these systems, other systems provide marketplaces for exchanging products, as opposed to information. Such marketplace systems enable users to offer their possessions for sale. Marketplace sellers may set their own prices, and buyers may select products and sellers based on product descriptions and reputations of the sellers.

Conventional marketplace systems provide basic means of tracking reputations of sellers. For example, a conventional marketplace system may define a user's reputation as the percentage of the user's reviews that are positive. Alternatively, a marketplace system may define a user's reputation as the sum of all positive reviews. The reputation systems provide no, or inadequate, means for ensuring that a user's reputation is not affected by unreliable reviews. As a result, a user's reputation does not reliably reflect the user's quality as a seller in the marketplace.

Accordingly, current reputation systems are ineffective as they are easily impacted by unreliable users. Further, reputation tracking systems are not currently available in information service systems.

Therefore, there is a need for an information service system that can enable real-time communications via one or more communication media. Preferably, such an information service system can provide a marketplace for exchanging information, along with a reputation management system that resists impact from user dishonesty and unreliability.

### SUMMARY

Exemplary embodiments of the present invention can include information service systems and methods. According to an exemplary embodiment, an information service system can comprise a search unit, a selection unit, a reputation-tracking unit, and a communications unit.

The search unit of the information service system can receive a query from a first user. The query can comprise a request for an information service to be provided to the first user. The query can further comprise one or more criteria for the information service, such as how the information service is to be provided, or such as a required minimum level of expertise for a provider of the information service. The search unit can search one or more databases or files associated with a plurality of available users. The search unit can identify one or more service options matching the first user's query.

The selection unit can then present the first user with the one or more service options matching the first user's query. The selection unit can sort, or rank, the service options according to default sorting parameters or sorting parameters provided by the first user. The first user can select one or more of the service options as the information service, and the selection unit can receive the first user's selection.

The communications unit can provide support for communications involved in providing the information service to the first user. For example, the communications unit can transfer data between the first user and a server. If a live information service provider is selected by the first user, the communications unit can transfer data between the first user and a provider of the information service. In an exemplary embodiment of the information service system, the communications unit supports real-time communication between the first user and the provider. For example, and not limitation, the communications unit may provide a virtual environment in which the first user and the provider can collaborate in real-time.

Exemplary embodiments of the information service systems and methods may be implemented on computer hardware, computer software, or both. Accordingly, all or part of the information service systems and methods may be embodied in computer-readable media and may be executable by one or more computer processing units.

These and other objects, features, and advantages of the information service systems and methods will become more apparent upon reading the following specification in conjunction with the accompanying drawing figures.

### BRIEF DESCRIPTION OF THE FIGURES

FIG. 1 illustrates a diagram of an information service system, in accordance with an exemplary embodiment of the present invention.

FIG. 2 illustrates an overlay network of the information service system, in accordance with an exemplary embodiment of the present invention.

FIGS. 3A-3B illustrate use of intermediate proxies in the information service system, in accordance with an exemplary embodiment of the present invention.

FIGS. 4A-4E illustrate operation of an exemplary iterative algorithm for calculating reputation indices of providers in the information service system, in accordance with an exemplary embodiment of then present invention.

FIG. 5 illustrates an exemplary method of performing the iterative algorithm for calculating reputation indices of providers in the information service system, in accordance with an exemplary embodiment of then present invention.

### DETAILED DESCRIPTION

To facilitate an understanding of the principles and features of the present invention, various illustrative embodiments are explained below. Exemplary embodiments of the invention comprise systems and methods for providing and supporting information services, such as exchanges of information between various parties. In particular, embodiments of the systems and methods are described in the context of information exchanges provided through a web environment. Embodiments of the invention, however, are not limited to this context. Rather, embodiments of the invention may be utilized through various communications media, such as via a telephone system, and may support various information services.

The components described hereinafter as making up various elements of the invention are intended to be illustrative and not restrictive. Many suitable components that would perform the same or similar functions as components described herein are intended to be embraced within the scope of the information service system. Such other components not described herein may include, but are not limited to, for example, components developed after development of the invention.

In an exemplary embodiment, the information service system can be a flexible and cyber-enabled distance-learning platform. For example, suppose a high school student has trouble with his algebra homework. The student can log into the information service system, and query the system for an algebra expert who: (i) has a specified minimum reputation index; (ii) is able to communicate through online whiteboard and voice; (iii) sells his services for no more than one dollar per minute; and (iv) is currently available to provide a live information service.

In response to the student's request, the system can identify service options matching the student's query. The system can additionally rank order the service options in order of recommendation based on the student's query. The student can select a service option. The information service system can then transmit data to the student for provision of the information service corresponding to the selected service option. In the case of a live provider, for example, the information service system can connect the student and the selected provider in a virtual environment. In the virtual environment, the selected provider can exchange information with the student in real-time, thereby providing an information service.

As a member of the information service system, the student can also offer his services for sale, and may be selected as a service provider for a different querying user. In an exemplary embodiment of the information service system, every member currently connected to the system can provide or receive an information service from another member. Furthermore, because the information service system can limit its provider searches to currently available users, members need not schedule meeting times in advance. Users need not meet at physical locations, as querying users can request providers capable of specified modes of communication. Accordingly, in an exemplary embodiment of the information service system, a user can receive sought information whenever and wherever, at an acceptable price, and from a provider personally selected by the user and deemed to be trustworthy.

Referring now to the figures, wherein like reference numerals represent like parts throughout the views, various embodiments of information service systems and methods will be described in detail.

### I. Overview of Exemplary Embodiments

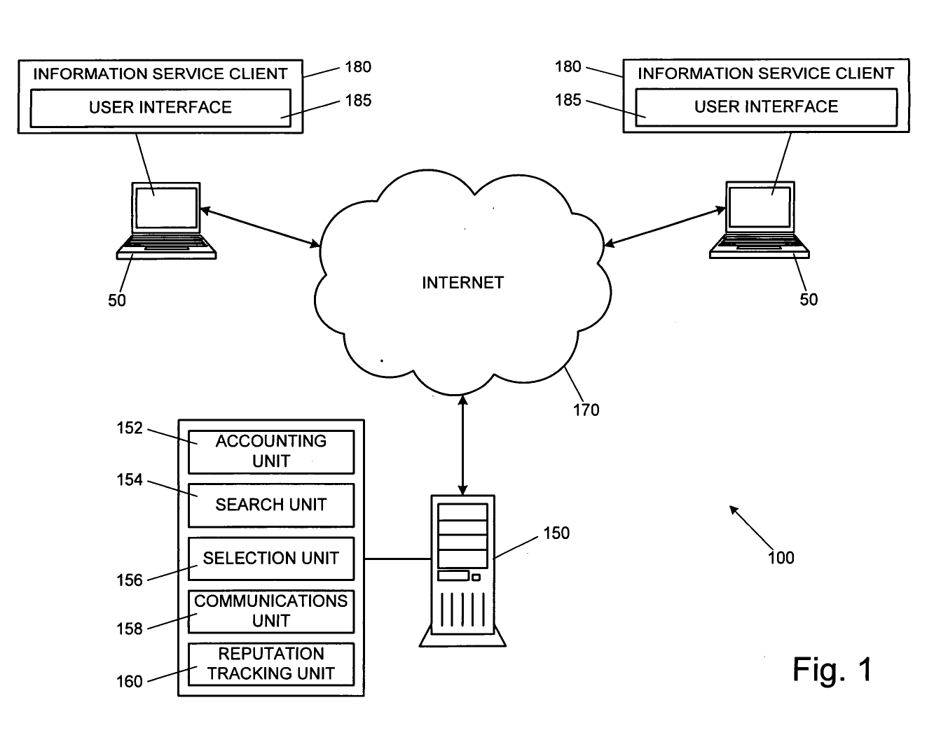

FIG. 1 illustrates a diagram of an exemplary embodiment of the information service system 100. As shown in FIG. 1, the information service system 100 can comprise one or more computers 50 and one or more servers 150. The computers 50 can be connect to each other and to the server 150 by one or more networks, such as the internet 170. Accordingly, the computers 50 and the server 150 can be in communication with one another.

Exemplary embodiments of the information service system 100 can be described in a general context of computer-executable instructions, such as one or more applications or program modules. Such computer-readable instructions can be stored on one or more computer-readable media associated with the computers 50 or the server 150, and can executed by one or more computer processing units on the computers 50 or the server 150. Generally, program modules can include routines, programs, objects, components, or data structures that perform particular tasks or implement particular abstract data types. Embodiments of the system 100 can also be practiced in distributed computing environments where tasks are performed by remote processing devices that are linked through the network 170. In a distributed computing environment, program modules can be located in both local and remote computer storage media and devices.

Each computer 50, or client computer, can be selected from various general purpose and special purpose computing devices and computing systems. For example, and not limitation, well-known computing systems, environments, and/or configurations that may be suitable for use with the invention include personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The server 150 can comprise the same or similar components as the client computers 50. Additionally, in some exemplary embodiments, the server 150 can comprise a server assembly distributed across two or more computing devices. Portions of computer-readable instructions on the server 150 can include, for example, instructions for implementing server-side processes of the information service system 100. Such server-side processes can include processing requests from the client computers 50, as well as routing data from a first client computer 50 to a second client computer 50. Additionally, if the information service system 100 comprises one or more web application programs, the server 150 can support a website, through which the client computers 50 can access the information service system 230 via web clients.

Each client computer 50 can access the information service system 100 through an application program, such as an information service client 180. The information service client 180 can, but need not, be a web application program executable by a web client. Through a user interface 185 of the information service client 180, a user at the client computer 50 can access various aspects of the information service system 100. The user interface 185 can be an interface in which the user can, for example, enter search criteria for an information service, receive search results of service options, select a service option as the information service to be received, and ultimately receive the information service.

The user interface 185 can be in communication with one or more units at the server 150 of the information service system 100. Such units can comprise modules, applications, devices, systems, services, or combinations or portions thereof. Such units on the server 150 can include an accounting unit 152, a search unit 154, a selection unit 156, a communications unit 158, and reputation tracking unit 160. The units can be in communication with one another for operation of the information service system 100.

A. Accounting Unit

The accounting unit 152 can manage a plurality of user accounts associated with the information service system 100. Each user account can be associated with a user, and data associated with the user can be stored with a reference to the user account of the user. Depending on implementation of the system, such data associated with the user can be stored on the server 150, on a client computer 50 of the user, or both.

One or more users of the system 100 can each have a profile associated with the user's account. The profile can contain data associated with the user. The profile can be set up by the user to include files of the users choosing. In an exemplary embodiment, however, the user account further includes one or more data or data files automatically associated with the user by operation of the system 100.

The profile can indicate various information related to the user. For example, the profile can indicate various combinations of the following: name, alias, location, birth date, date user account was established, one or more reputation indices, one or more reliability indices, area of expertise, level of expertise in one or more areas of expertise, availability, and one or more data files associated with the user. In an exemplary embodiment, some data associated with a first user account can be visible to other user's viewing the first user's profile, while some other data can remain hidden from the others users. Which data is visible and which is hidden can depend on various factors, such as user statuses of the other users. For example, if another user is an administrator, all data associated with the first user's account can be visible to the other user. Visible data and, in some embodiments of the information service system 100, hidden data can be searchable by the search unit 154 or other users.

As mentioned above, the user account can indicate one or more reputation indices and one or more reliability indices associated with the user. Such indices can be tracked and managed by the reputation tracking unit 158, as described further below.

Data files associated with the user account can be uploaded by the user or otherwise associated with the account by the user or the accounting unit 152. The data files can comprise information about the user that the user would like made available on the information service system 100. For example, and not limitation, a data file can be created when a user completes a form or answers questions presented by the information service system 100. For an additional example, a data file can include an uploaded scholarly research paper, evidence of the user's educational background, or a resume. Data files need not consist only of text or text-based documents. Data files can include, for example, one or more audio, video, or multimedia files, such as records of prior information service sessions.

The accounting unit 152 can associate an availability status with each user's profile. A user's availability status can indicate, for example, whether the user is logged in to the information service system 100 or whether the user is currently available to act as a provider in an information service. The availability status can also specify the user's availability with respect to certain categories of information services. For example, the user's availability can indicate that the user is currently available to provide an information service in a first area of study, such as algebra, but not in a second field of study, such as geometry. Additionally, the availability status can distinguish between communication media of information services. For example, the user's availability status can indicate that the user is available for instant messaging but not for web camera communications.

The user's availability status can be set by a default operation of the information service system 100 or by the user's affirmatively indicated availability. For example, and not limitation, when the user logged into the system 100, the accounting unit 152 can automatically set the user's availability status to “available” in all fields of study for which the user has previously indicated willingness to participate in information services. Additionally or alternatively, the accounting unit 152 can prompt the user to indicate an availability status when the user logs into the information service system 100. If the user begins active participation in an information service on the system 100, the user's availability status can be automatically set to “not available.”

The accounting unit 152 can retain prices of various information services, and can transfer payments between service recipients and providers when information services are provided. Additionally, the accounting unit 152 can track and manage users' funds, accounts receivable, and accounts payable.

Payment for information services can be in the form of, for example, goods, real currency, or virtual currency. For instance, in some exemplary embodiments, service recipients can pay providers with American dollars or other real currency. In other exemplary embodiments, service recipients can pay providers with rewards, points, or virtual credits useable only on the information service system 100 or other associated systems. Providers can set their own prices for information services offered. After an information service is provided to a user, the user can pay the provider of the information service in an amount equal to the price set by the provider for the information service.

B. Search Unit

The search unit 154 can process requests for information services received through the user interface 185 or other means. When a user requests an information service, the user can enter one or more criteria relating to the information service. The search unit can receive such criteria and identify one or more service options that meet the criteria.

Each service option can be, for example, a live information service session with a currently available provider, an information service record, or a subscription service. In a live information service session, the provider communicates with the requesting user and, in an exemplary embodiment, the requesting user can also communicate with the provider. An information service record can comprise a stored recording of a prior information service session. In lieu of connecting the requesting user with a live provider, the information service system 100 can transmit such a stored record to the requesting user. Providers can have the option of setting different prices for live versus pre-recorded information services. For example, a provider can set a lower price for an information service record in which he or she acted as provider than for a live information service, which would likely be more customized to needs of the requesting user. A subscription service can comprise a series of live or pre-recorded information sessions.

Search criteria entered by a requesting user can include various parameters, such as, for example, type of service (e.g., live, pre-recorded, subscription), medium of communication, geographic location of the service provider, field of study, experience level in the field of study, current availability, availability at a specified time, language of communication, reputation index in the specified field of study, and length of time the service provider has been subscribed to the information service system 100. Many combinations of these and other criteria can be specified and defined by the requesting user.

For example, and not limitation, the requesting user can request a live provider having at least a specified reputation in a given field, costing no more than a specified amount per hour, and able to communicate via web camera. Alternatively, in some exemplary embodiments, the requesting user can be less specific. In that case, the search unit 154 can utilize a default search criteria to supplement criteria not provided by the requesting user. For example, if the requesting user indicates that he desires a geometry tutor, the search unit 154 can search for live providers having a predetermined minimum reputation in geometry.

Before a requesting user submits a set of search criteria, the search unit 154, through the user interface 185, can display to the requesting user various statistics related to expected search results. For example, and not limitation, as the requesting user enters and changes search criteria, the search unit 154 can display and dynamically update pricing statistics related to the expected search results. For further example, the search unit 154 can display an average cost of receiving an information service matching the search criteria. If the user changes an aspect of the search criteria, such as by increasing a minimum reputation index, the search unit 154 can update the average cost to reflect the average cost given the increased minimum reputation index.

After the requesting user submits the search criteria, the search unit 154 can perform various actions to identify service options matching the criteria. For example, and not limitation, the search unit 154 can query one or more databases, search and analyze one or more data files associated with providers, and search and analyze one or more other users' profiles. In an exemplary embodiment of the information service system 100, the search unit 154 can search data associated with available users to identify matching live providers among the users. The search unit 154 can also search profiles of both available and unavailable users to identify matching information service records and subscription services associated with the users. In an alternative exemplary embodiment, however, the search unit 154 can limit its searches to users who are currently available to provide requested information service in a live setting, as indicated by the other users' availability statuses.

In comparing search criteria to potential service options, the search unit 154 can search various data in, or associated with various users' profiles. The search unit 154 can search data entered by the users themselves, as well as data files uploaded by the users or otherwise accessible by the information service system 100. Searching data files can comprise extensive data mining and analysis, including optical character recognition (OCR), image or video analysis, and text searching.

A process of searching for service options can be dependent on arrangement of the network for the information service system 100. For example, if the network comprises peer-to-peer aspects, each client computer 50 can store profile data associated with a user at that client computer 50. Such data can, but need not, be indexed on the server 150 to make searching more effective. In a peer-to-peer network, the search can be performed across multiple computers 50 participating in the system 100. Alternatively, if the network is a client-server network, then the server 150 can retain profile data for users of the information service system 100. In that case, the system would likely require greater overhead, but searches can be restricted to the server 150, which can contain all, or most, data relevant to system users.

Based on results of searches performed on one or more databases, data files, or the like, the search unit 154 can compile a list of service options matching the requesting users' search criteria. In some exemplary embodiments, the compiled list can include service options that are close matches, as opposed to exact matches, to the request. For example, a service option can be included in the compiled result list if the service option meets at least one of the requesting user's search criteria, or almost meets one or more of the user's search criteria. The compiled result list of service options can include, for example, various combinations of live providers, subscription services, and information service records. The search unit 154 can communicate the result list to the selection unit 156.

C. Selection Unit

The selection unit 156 can present the result list of service options to the requesting user, and can receive the requesting user's selection of the information service from among the presented service options.

As presented to the requesting user, the list of service options can take many forms adapted to communicate relevant details of the service options to the requesting user. For example, the list of service options can be presented in a text-based format listing the service options, providers associated with the service options, or a combination of both. Otherwise, the list can be presented in a pull-down menu, a set of radio selection button associated with each service option, a set of links to profiles of providers associated with the service options, a grid of photographs of providers associated with the service options, or many combinations of the above or other manners of presenting the service options. In an exemplary embodiment of the information service system 100, various information relating to the service options is presented along with the service options. For example, and not limitation, reputation indices of providers associated with service options may be presented to the requesting user along with the service options.

The service options can be presented to the requesting user in various arrangements and orderings. For example, the requesting user can provide one or more sorting or ranking parameters, and the service options can be presented in a sorted order according such parameters. The service options can be sorted, for example, by experience level of an associated provider in a specified field of the information service, by a reputation index of an associated provider, by price, by geographic location of an associated provider, in random order, or by many other characteristics of the service options.

The requesting user can select one or more of the service options as the information service to be provided to the requesting user. Such selection can take many forms, and may be at least partially dictated by the format in which the service options are presented to the requesting user. For example, if the service options are presented in a list comprising radio buttons, the requesting user can click on one or more of the radio buttons and then submit his selection. Alternatively, the requesting user can click a name, photograph, or other representation of an associated provider to indicate selection of a service option.

After the requesting user selects a particular service option as the information service to be provided, the communications unit 158 can support delivery of the information service to the requesting user.

D. Communications Unit

The communications unit 158 can support communications for the provision of information services through the information service system 100 Although an exemplary embodiment of the communications unit 158 is described herein, various mechanisms can be used in the information service system 100 to support communications. Further, the communications unit 158 can be a stand-alone unit or can be integrated into various systems and methods other than the information service system 100 and associated methods.

An exemplary embodiment of the communications unit 158 can transmit data to, between, and among various locations of users of the information service system 100. Data can be transmitted, for example, from the server 150 to a user, back and forth between two users, between multiple users for group information exchanges, or from one user to a group of other users. When data arrives at a user's computer, such data can be displayed to the user via the user interface 185.

In an exemplary embodiment of the information service system 100, communication between users can occur via various media, including, for example, data, voice, image, video, graphics and animations, are supported. In a further exemplary embodiment, participants of an information service can collaborate in a virtual environment, which can include a virtual whiteboard receiving writings from the participants. Accordingly, data transmitted between users and displayed through the user interface 185 can comprise, for example, text, voice, video, graphics, application sharing, virtual whiteboard drawings, tablets, desktop sharing, and various other forms of data.

Preferably, the communications unit 158 can enable users to experience excellent audio and graphics quality and reasonable video quality. Because many requesting users can use the system 100 concurrently, multiple information service sessions can occur simultaneously between multiple sets of users. Accordingly, multiple instances of interactive media communications may occur concurrently. Ensuring high-quality coexistence of multiple concurrent interactive media applications (e.g., video-telephony, whiteboard, or document-sharing) represents a challenging problem, as such applications can share and compete for the same network resources. To alleviate the resource allocation issues, the system 100 can implement application prioritization, application-aware content adaptation, and cooperative media-aware error-control.

The communications unit 158 can store a record of information services or other data transmitted between users. In an exemplary embodiment of the communications unit 158, such record can be stored in a database on the server 150. Alternatively, an information service record can be stored on a client computer 50 of a provider of the information service. The stored record can comprise a complete or partial record of the information service. For example, and not limitation, if participants to an information service are recorded via webcams at the participants' respective computers, the recorded video data of one or more of the participants can be stored.

Records of previous information service sessions can be utilized by other units of the information service system 100. For example, and not limitation, such records can searchable by the search unit 154, and can be presented to requesting users in response to their information service requests.

Interactive multimedia communications over the internet, such as various communications of the information service system 100, pose several challenging problems due to stringent delay and loss requirements for achieving acceptable streaming multimedia. Networks between two users, such as a requesting user and a selected provider, may have limited bandwidth and complex network dynamics. Accordingly, an exemplary embodiment of the information service system 100 can implement one or more means to improve qualities of streaming multimedia between users.

To satisfy quality of service (QoS) requirements in the information service system 100, the communications unit 158 can comprise two classes of solutions. The first class can focus on transport and network layer solutions for interactive multimedia, whereas the second class can focus on coding techniques. Both classes can work hand-in-hand to provide an error-resilient information pipe with acceptable delay characteristics.

1. Transport and Network Layer Solutions for Satisfying QoS Requirements

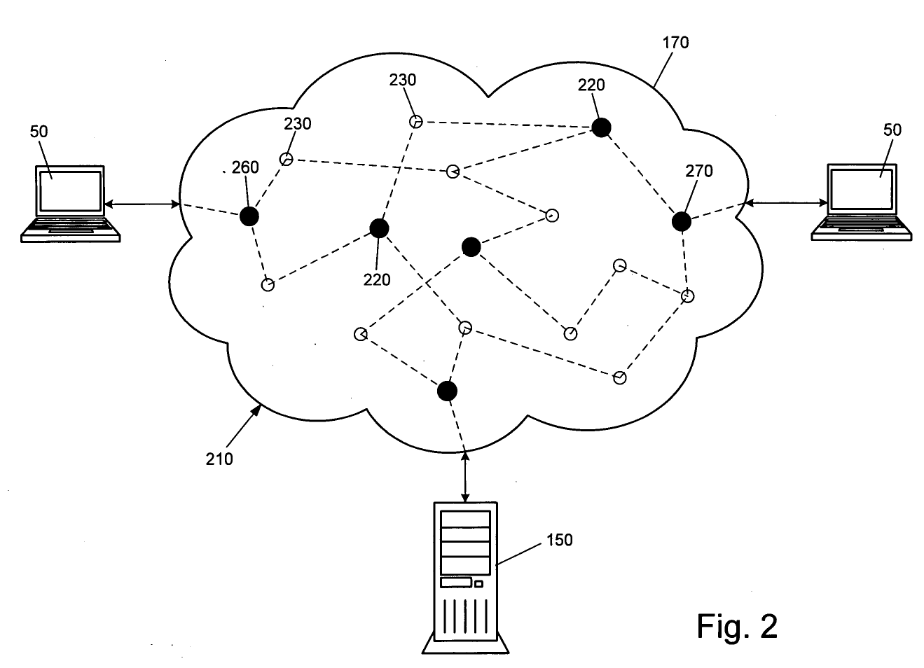

FIG. 2 illustrates an aspect of the first solution class, a transport and network layer solution. As shown in FIG. 2, the communications unit 158 can establish an overlay peer-to-peer network 210. The overlay network 210 can comprise a set of overlay physical nodes 220, such as computers 50 of users, comprising a network layer supported by an underlying network 170, such as the internet. In this case, the overlay physical nodes 220 can comprise computers 50 of the system users.

In FIG. 2, each open or closed dot represents a physical location 220 or 230 making up the internet 170. Such physical locations 220 and 230 can comprise both the overlay physical nodes 220, which are represented by closed dots, as well as other physical nodes 230 of the underlying network, which are represented by open dots. The information service system 100 may have no control over how data is routed at the physical locations 230 that are not part of the overlay network 210 of the information service system 100. When data arrives at a first overlay node 220, the communications unit 158 can direct such data to a selected second overlay node 220, but the specific path between the overlay nodes 220 can be determined by rules of the underlying network. Although the communications unit 158 on the server 150 can coordinate data transmission between users and to and from the server, the overlay nodes 220 can also comprise computer-readable instruction for receiving and transmitting data through the overlay network 210.

Traditional network-layer QoS methods can offer flow classification and prioritization. In other words, traditional networks attempt to recognize and categorize data and, based on categorization, prioritize data flows. Traditional QoS, however, merely classifies flows with respect to their types as seen from a network layer, thereby preventing adaptation of the content based on network conditions. To overcome this limitation, the information service system 100 can utilize a QoS approach that can classify and prioritize flows as seen from the application layer. In other words, the system 100 itself can classify and prioritize flows instead of depending on the network to do so. Accordingly, because the system 100 has access to detailed information regarding types of data to be transferred between users, data flow can be more effectively prioritized to ensure high-quality communications in streaming media.

The application-layer QoS functionality can be provided through the overlay nodes 220, which can be responsible for monitoring network statistics to optimally manage available bandwidth of the underlying network. The overlay nodes 220 can support adaptability and scalability of the network, and can help meet timeliness requirements of data flows.

Cooperative media-aware error-control techniques utilized in the system 100 can integrate three crucial components of reliable multimedia communications: (a) multi-path routing, (b) error-recovery through intermediate proxies, and (c) network-adaptive retransmission-timeout. To increase efficiency and reduce data loss and delay, the communications unit 158 of the information service system 100 can utilize a joint multi-path routing and intermediate proxy error-control protocol utilizing a retransmission-timeout method.

a. Multi-Path Routing

Several transmission diversity techniques can improve reliability of streamed media by mitigating severe effects of complex network dynamics of the underlying network. For instance, path diversity can be achieved by transmitting media content over different paths. Path diversity through multi-path routing can ensure that, because data flows do not occur along the same paths repeatedly, congestion and data loss can be reduced along the paths. By integrating diversity elements into a communications framework in response to potential error sources, erroneous transmission paths can be replaced with more reliable paths. Additionally, server diversity can be achieved by replicating media content among several servers, thereby reducing delays due to over-burdened servers.

Generally, multi-path routing comprises each node 230 detecting network characteristics for one or more paths between the node 230 and other nodes 230 in the network. Such network characteristics can include, for example a path length between the node 230 and a second node 230 and a delay time for transferring data between the node 230 and a second node 230. Network characteristics can be stored in one or more routing tables stored at the node 230, which can be examined prior to routing a data packet from the node 230.

Multi-path routing can reduce shortfalls of single-path routing by improving on-time delivery-rate. For example, if two overlay nodes 220 have two or more different paths between them, the first path may deliver the packets on time when the second path fails to deliver the packets, or vice versa. The overlay nodes 220 can monitor and store data related to transmission times and traffic through the paths. Hence, by distributing the packets over the paths based on such network characteristics stored in the routing tables, the on-time delivery rate can be maximized.

Several multi-path routing protocols have been developed for overlay networks. Existing approaches, however, have been primarily designed to provide only basic routing functionality. These approaches lack the capability to perform application-optimized path evaluation, path-switching, and path selection techniques. To address these problems, the communications unit 158 can use a rate-distortion, optimized multimedia delivery protocol that considers both media characteristics (e.g., such as media dependency structure), network conditions, and application requirements (e.g., such as timeliness requirements, which can vary between media types). The proposed protocol can determine when and over which paths to send each packet to maximize an expected quality at the users' computers 50.

b. Use of Intermediate Proxies

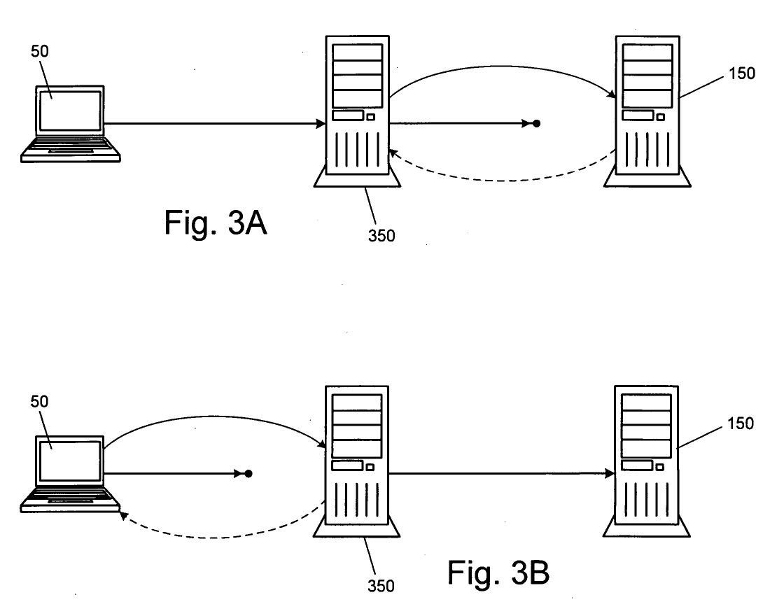

As mentioned above, the communications unit 158 can further implement an intermediate proxy approach to enable use of additional error-recovery functionalities along communication paths. An intermediate proxy 350 (FIG. 3) can be located along a path between a user's client computer 50 and the server 150, and can communicate data between the two. The communications unit 158 can implement a form of error detection, which will be discussed below, such that the client computer 50, the server 150, and the intermediate proxies 350 can become aware of when packet transmission fails.

FIGS. 3A-3B illustrate exemplary error recovery of the communications unit 158 through use of intermediate proxies 350. As shown in FIGS. 3A-3B, an intermediate proxy 350 approach can operate on two principles. First, as illustrated in FIG. 3A, a packet that is lost between an intermediate proxy 350 and a client computer 50 can be recovered early by limiting retransmission request to the intermediate proxy 350, as opposed to making the same request to the server 150. In other words, when a packet is lost between the server 150 and the client computer 50, the client computer 50 can request retransmission of the packet. If the packet was lost between the intermediate proxy 350 and the client computer 50, then when such retransmission request reaches the intermediate proxy 350, the intermediate proxy 350 can retransmit the packet to the client computer 50 without forwarding the retransmission request back to the server 150. This can be referred to as early transmission.

Second, as shown in FIG. 3B, when a packet that is lost between the server 150 and the intermediate proxy 350, the packet can be recovered quickly by the intermediate proxy 350 if the retransmission request is initiated by the intermediate proxy 350, as opposed to waiting for the client computer 50 to re-initiate the request. In other words, when a packet is lost between the server 150 and the client computer 50, the intermediate proxy 350 can detect the packet loss before the client computer 50 can detect such loss. Accordingly, the intermediate proxy 350 can request retransmission of the packet from the server 150. This can be referred to as fast transmission.

The intermediate proxies 350 of the system 100 can comprise one or more of the overlay nodes 220. Effectiveness of the proposed intermediate proxy approach can be dependent on the placement and selection of the intermediate proxy nodes 350 among the overlay nodes 220. The intermediate proxy nodes 350 can be distributed to maximize network-wide expected performance. A network-adaptive quality metric can represent the on-time delivery rate between the server S and a specific client computer C via a given intermediate proxy node 350. The quality metric Q_{ρ} for the intermediate proxy node ρ can be defined as follows:

Q_{ρ}=P[tₑ₂ₑ(ρ)≦t_{Δ}]+ε_{S}*P[t_{arq}(S)≦t_{Δ}]+(1−ε_{S})*ε_{ρ}*P[t_{arq}(ρ)≦t_{Δ}],

where P[ ] represents the empirical probability that an event will occur; t_{Δ} is the maximum tolerable delay; tₑ₂ₑ(ρ) is the end-to-end delay between S and C via the selected intermediate proxy node ρ; ε_{S} is the probability that transmission from S to ρ is a failure; ε_{ρ} is the probability that transmission from ρ to C is a failure; and t_{arq}(N) is a total end-to-end transmission delay after an error-recovery packet is requested from overlay node N, where N can be S or ρ.

The proxy node with the highest calculated quality metric can be assigned as an intermediate proxy node to serve the given client computer 50. The intermediate proxy node 350 can be found using a binary-search approach that initially selects an arbitrary node and performs the quality metric calculation. The proxy node selection can move toward the server 150 or the client computer 50 depending on results of the above equation or other network statistics.

C. Network-Adaptive Retransmission and Timeout

Because multimedia transmissions often require low packet delay for a recipient to understand the multimedia data, time-constrained error recovery can be essential to reliable delivery of multimedia transmissions. However, while it is important to identify lost or delayed packets, it can also be important to minimize erroneous timeouts and incorrect packet loss determinations. Minimizing such errors can reduce the occurrence of unnecessary retransmissions.

Retransmission timeout (RTO) can be defined as a maximum duration to make a final determination as to whether a packet is lost. Selecting an optimal RTO can be crucial to performance of the information service system 100. For instance, if the RTO is too low, erroneous timeouts and unnecessary retransmissions can occur undesirably often. On the other hand, if the RTO is too high, recovery of lost data packets can be delayed unnecessarily. Accordingly, an RTO estimation method can be provided to quickly detect packet losses and to timely initiate error recovery procedures. Designing an RTO mechanism can require a network-adaptive delay predictor to determine an RTO value that jointly optimizes media quality and network utilization.

There may exist an inherent dependency structure among transmitted data packets, where one or more dependent packets are not useful to the recipient client computer 50 without receipt of one or more other packets. Such dependency is not uncommon in transmission of media data. An exemplary embodiment of the communications unit 158 can provide a media-aware RTO protocol to optimize error control for each media packet based on its importance. The communications unit 158 can use a multi-step autoregressive predictor to estimate initial delay values, which can then be used to determine the probability of on-time delivery for each transmitted packet. Then, using the dependency structure among the transmitted packets, the probability of successfully decoding the nth packet, Pₙ, can be determined as follows:

$${P}_{n} = {p}_{n} \times {\prod }_{{n}^{′} ∈ {D}_{n}} {P}_{n} ,$$

where pₙ is the on-time delivery probability for n, and Dₙ is the dependency set of n (i.e., the recipient client computer 50 needs to receive all packets in Dₙ to decode the nth packet). After determining Pₙ, the optimal timeout values to maximize the decoding probability for each packet can be calculated. In practice, an estimator can be used to compute the coefficients for the prediction model, which can then be used to determine the optimal timeout parameters.

2. Coding Solutions for Satisfying QoS Requirements

A second set of solutions for satisfying QoS requirements in the information service system 100 can comprise one or more coding solutions at the application and network levels. While all types of media can be delivered via the same overlay network 210, certain types of media can be assigned higher priority than other media types. For example, and not limitation, voice communications can be assigned higher priority than drawing and video communications, which can be understood by a recipient at lower quality. The communications unit 158 can enable real-time interaction by implementing rateless coding, unequal error protection (UEP), or a combination of rateless coding and UEP.

a. Rateless Coding

When data is sent from a first client computer 50 to a second client computer 50, such data can be delivered by routing through the overlay network 210. A first overlay node 220 receiving the data can be referred to as a source node 260 for the data transmission. The source node 260 can direct the data toward a second overlay node 220, which can be referred to as a destination node 270. The destination node can be located a relatively short path distance from the intended recipient client computer 50. The data can be routed form the destination node to the recipient client computer 50.

Rateless codes can be implemented at the source node 260 to address the issue of optimizing the distribution of modern error control. For example, and not limitation, Luby Transform (LT) codes, Raptor codes, Online codes, or various combinations of such rateless codes can be implemented by the communications unit 158.

Rateless codes, or fountain codes, are a form of erasure codes having no “rate.” In other words, an encoder at a source node 260 can generate a potentially limitless number of encoded packets from an original set of information packets. To generate each encoded packet cᵢ, the encoder can select dᵢ information packets uniformly at random from the entire set of information packets. The encoder can then combine the selected packets via one or more XOR operations. The number dᵢ, which defines a degree of the encoded packet cᵢ, can be a random number generated based on a degree of (i.e., a number of paths extending from) the source node 260.

The source node 260 can distribute the encoded packets along multiple paths extending from the source node 260. It is expected that not all of the encoded packets will reach the intended destination node 270. The destination node 270 can receive one or more of the encoded packets and can attempt to decode the packets to reconstruct the original packets. The destination node's chance of successfully decoding the received encoded packets can dramatically as more encoded packets are received. For example, for raptor codes having k=1024 original information packets, when k+12 encoded packets are received, the chance of failure can be as low as 10⁻³. In contrast, when k+24 packets are received, the failure probability can decrease to 10⁻⁶.

Various combinations of encoding and decoding among the physical nodes can be utilized in transmitting a set of packets between the source node 260 and the destination node 270. For example, in a first exemplary embodiment, encoding can be performed only at the source node 260. Overlay nodes 220 between the source node 260 and the destination node 270 can merely forward the encoded packets toward the destination node 270. As a result, the system 100 can dynamically adapt to path loss, and can achieve overall end-to-end capacity of the path asymptotically.

In an alternative exemplary embodiment of the communications unit 158, the source node 260 can encode a set of packets for transmission and can direct the encoded packets toward the destination node 270. Each overlay node between the source node 260 and the destination node 270 can decode and then re-encode the data packets before forwarded them on to the destination node 270. This embodiment can achieve a min-cut capacity of the path, which is greater than the end-to-end capacity. This benefit, however, comes at a cost of computation and latency resulting from additional computation required for the additional decodings and encodings. In particular, the accumulated latency becomes can increase as the number of overlay nodes in the path grows. This can be particularly prohibitive in an interactive real-time scenario such as is expected in various embodiments of the information service system 100.

Yet another exemplary embodiment of the communications unit 158 can maximize throughput from the source node 260 to the destination node 270 through binary random coding. In such an embodiment, the intermediate overlay nodes 220 need not perform any decoding, but binary random coding can be performed at each overlay node 220. This solution is inherently distributed. Consequently, although overlay nodes 220 necessarily communicate with one another for transmitting packets, they need not communicate with one another for encoding purposes. Further, this approach can improve the multicast throughput over traditional methods in the overlay network 210. This embodiment of the communications unit 158 can increase information throughput of a unicast transmission (i.e., sending data to a single destination node) in the overlay network 210. Inherently, this embodiment of the communications unit 158 achieves the min-cut capacity of the unicast.

An exemplary embodiment of the communications unit 158 is capable of transmitting various media types, including, for example, voice, drawing, and video. To maximize end-to-end quality of a media transmission, coding for the communications unit 158 can consider not only quality weights assigned to each media types, but can also consider the relative importance of individual data packets within a media transmission.

b. Unequal Error Protection (UEP)

An exemplary embodiment of the communications unit 158 can utilize rateless coding in conjunction with unequal error protection (UEP) properties. In determining a priority of data in transmitting communications data between nodes 220, the communications unit 158 can consider not only the assigned quality weights to each media type, but also the relative importance of each packet. Error protection can be applied non-uniformly to data packets based on the quality weights and importance of such data packets. UEP can be utilized to provide greater error protection for higher priority packets, such as packets with higher quality weights and/or higher importance than other packets.

For example, and not limitation, the communications unit 158 can categorize each data packet into one of two groups, more important packets (MIPs) and less important packets (LIPs). MIPs can include packets having high quality weights, such as voice transmissions, and packets having relatively high importance. MIPs can be allotted stronger error protection than allotted to LIPs. The communication unit 158 can use a single rateless code to encode the MIPs and LIPs while providing two multiple, such as two, levels of protection. If a set of unencoded data comprises MIPs and LIPs comprises N packets of data, the number of MIPs can be n₁=αn, and the number of LIPs can be n₂=(1−α)n.

An unequal error protecting LT code (UEP-LT code) can be constructed similar to a traditional LT code, except that the parity packets can select their adjacent input packets (i.e., the original packets that are going to be encoded) non-uniformly at random via an optimized distribution. A parity packet with degree d can select d₁=min([αdk_{M}], n₁) input packets from MIPs (for some k_{M}>1) and d₂=d−d₁ input packets from LIPs, where [x] denotes the nearest integer to x for a variable x. The parameter k_{M} can determine the error protection level of a packet, and a larger k_{M} can result in greater protection for MIPs. Iterative decoding can be implemented efficiently and in linear time to achieve the UEP-LT coding. A joint source and channel coding algorithm can adapt UEP rateless parameters (i.e., non-uniform choices of degree distributions) to the relative importance of the packet stream components.

Network coding, such as that described above, by an exemplary embodiment of the communications unit 158 is performed within a finite field. Operations performed in the finite field result in one or more elements of the same finite field. The size of the finite field chosen for the network coding can have a two-fold effect on the coding scheme: First, the optimality of network throughput resulting from network coding can be directly related to the size q of the finite field chosen. Second, the complexity of encoding can increase with the size of the field. With an increase in size of the finite field, the coded scheme can becomes more rate-optimal and computationally complex.

For sufficiently large storage buffer sizes at the overlay nodes 220, variation in the throughput loss offered by different finite fields is minimal. When the memory size is sufficiently large, one can employ random network coding over a binary finite field, thereby greatly decreasing computation costs associated with encoding at the overlay nodes. For example, if a field of size q=2^{r} is used to generate a single encoded packet from m packets of size L by selecting packets in a Bernoulli fashion with probability p, one would perform approximately pmL/r multiplications and additions in F_{2̂r}. The number of binary additions that performed can increase with r, as complexity for computing the result of the multiplication of two numbers of size r bits each is superlinear in r.

As an illustration, consider an overlay network 210 of three disjoint paths from a source node S to a destination node D, with each path of length 10 hops. Further, suppose that each hop has a packet erasure probability of ε=0.25 and a bandwidth of 100 packets per second. For small buffer sizes m, coding over smaller fields can yield poorer throughput. For sizes comparable to m=20, however, the difference in the schemes for binary fields and a large fields can be less than 8%. Therefore, an exemplary embodiment of the communication unit 158 can employ binary network codes to gain large computational benefits at a relatively low throughput cost.

The communications unit 158 can implement a new coding scheme, whereby an overlay node 220 can transmit random linear combinations, over a binary field, of all packets it has currently received. In other words, the overlay node 220 can select a random subset of its received packets, and each packet can be chosen with a predetermined probability p. The overlay node 220 can then create encoded packets by performing one or more XOR operations on the selected packets. The packets can be processed as they are received, so no latency is needed when awaiting packet arrival at intermediate overlay nodes 220. Decoding at a destination node 270 can comprise little more than inverting a matrix at the destination node 270.

Accordingly, through various combinations of an overlay network, intermediate proxies, rateless coding, and unequal error protection, the communications unit 158 can provide multimedia transmissions having sufficient quality for understandability by the recipient.

E. Reputation Tracking Unit

The reputation tracking unit 160 can manage the reputations of service providers using the information service system 100. Although an exemplary embodiment of the reputation tracking unit 160 is described herein, various mechanisms can be used in the information service system 100 to track reputations of service providers. Further, the reputation tracking unit 160 can be a stand-alone unit or can be integrated into various systems and methods other than the information service system 100 and associated methods.

In an exemplary embodiment, the information service system 100 does not provide employed experts to perform as reputable tutors or service providers on the system 100. Users can choose to interact with other users about whom they may have no outside knowledge. Therefore, it can be important to provide some indication of the reputability of various users as providers. An exemplary embodiment of the reputation tracking unit 160 can provide valuable information to users regarding the reputations of various providers. The reputation tracking unit 160 can enable the information service system 100 to create a free marketplace for the exchange of information services. Providers of the information service system 100 can set their own prices and, through the reputation tracking unit 160, such providers have associated feedback or reputation indices. Consequently, a user of the system 100 can select an information service from a provider having an acceptable price and reputation for the user's personal demands. In other words, as in a free market, sale prices can be determined completely by buyers and sellers.

At the end of an information service, recipients of an information service can be asked to review, or rate, a provider's quality as a service provider. For example, a service recipient can be asked to provide written feedback, a set of ratings, or both.

Written feedback can be requested of a service recipient in various manners, such as by displaying a feedback form or questionnaire for the service recipient to complete. In an exemplary embodiment, the service recipient can be presented with a feedback form requesting the service recipient's general comments, responses to one or more specific questions, or a combination thereof. The service recipient can provide feedback by entering text-based comments or responses. Such feedback can be transmitted to the server and stored. Users of the information service system 100 can access the stored feedback, which can help the users determine which providers to select for provision of future information services.

A service recipient can provide a set of ratings for a provider of an information service. The set of ratings for an information service can include separate ratings for various aspects of the provider's performance. For example, a first rating can apply to the provider's knowledge of the subject, while a second rating can apply to the provider's ability to explain the subject matter. The various ratings can be transmitted to the server 150 or other location, stored, and used to calculate the provider's reputation indices as described further below. Reputation indices for providers can be updated in a batch, such as at the end of each day or, preferably, in real-time as ratings are received.

Each reputation index of a provider can relate to the provider's overall quality, quality in a specific aspect of providing an information service, or quality in a specific field. For example, and not limitation, the provider can have a single reputation index indicating the provider's overall quality of service. Alternatively, the provider can have one or more separate reputation indices for each field and/or each rating category. For example, a rating can have one or more semantic aspects, such as knowledge of the provider in the field, politeness, and response time. For another example, the provider's reputation index in a first field, such as science, can differ from his reputation index in a second field, such as engineering. Further, the reputation tracking unit 160 can adjust granularity of reputation indices. If an expert has several ratings in mathematics, the system automatically further subdivides the expertise area into, say, algebra, discrete mathematics, calculus, etc. In an exemplary embodiment of the reputation tracking unit 160, a provider's first reputation index can be separated two or more reputation indices as the provider receives more ratings relevant to the first reputation index. For example, a provider's reputation index and math can be divided into a reputation index for algebra and a reputation index for geometry, after the provider receives sufficient ratings in both algebra and geometry.

A provider's reputation index can be calculated based on a combination of ratings received for the provider. In an exemplary embodiment of the reputation tracking unit 160 of the information service system 100, a provider's reputation index calculation is based not only received ratings but also on calculated reliability indices of the raters. By assigning reliability indices to raters (i.e., requesting users leaving ratings for their providers), the reputation tracking unit 160 can provide immunity, or reduce the effect of malicious or otherwise untrustworthy raters. Additionally, if raters are aware their reliability indices are at risk when they provide ratings, they may be more likely to provide honest or reliable ratings. Untrustworthy raters can include, without limitation: 1) malicious peers who intentionally give incorrect ratings to disrupt proper operation of the reputation tracking unit 160; 2) honest but abnormal peers who are unable to provide a high quality rating; and 3) selfish peers who intentionally aim to increase or decrease the reputation of a provider.

Untrustworthy users can provide unreliable ratings in a variety of patterns. These patterns can include the following:
Bad mouthing: Malicious or selfish raters collude and attack service providers with the highest reputations in order to undermine them. An objective of bad mouthing is to increase the demand for service providers with lower reputation indices by negatively impacting providers with higher reputation indices.
Ballot stuffing: Malicious raters collude in favor of a provider with a low reputation index to increase the reputation index of the provider.
Selective attack: Malicious raters can select and attack one or more providers whose reputations are the most vulnerable because the providers have received few ratings thus far. The attack on these vulnerable providers are either in the form of reducing or increasing their reputation indices
Mixed attack: Malicious raters execute a combination of attacks that are listed above.
   Preferably, the reputation tracking unit 160 can reduce the impact of these and other patterns of unreliable ratings.

Some mechanisms already exist for calculating reputations of users of various other systems. Past reputation mechanism can be classified into two broad categories, global reputation mechanisms and personalized reputation mechanisms. A basic global reputation mechanism is used in eBay®, for example. Other web sites, such as Amazon®, Epinions®, and AllExperts® use slightly more advanced reputation mechanisms. These and other past reputation mechanisms are based on a total, average, or weighted average of ratings received for a product or user. All of these past reputation mechanisms are vulnerable to the above-described patterns of unreliable ratings. In an exemplary embodiment, the reputation tracking unit 160 provides a means for reliably tracking providers' reputations without overburdensome calculations.

The reputation tracking unit 160 can implement an iterative method of calculating reputation indices based on ratings and reliability indices of raters. Although received ratings can be on various scales, the example provided assumes that ratings are in a range from one to five, where five is the best possible rating.

The reputation tracking unit can calculate provider reputation indices according to the following iterative algorithm: Let TRⱼ for j=1, . . . , k be a reputation index for a given provider of k total providers. Let i represent a rater, such that rater i can rate provider j, and such rating can be represented by TRᵢⱼ. For example, and not limitation, TRᵢⱼ can be an integer between one and five, inclusive, with five being the best rating available.

The reputation tracking unit 160 can collect and aggregate all TRᵢⱼ for a provider j, to calculate the reputation index TRⱼ, which can be in the same range as TRᵢⱼ, for example, from one to five. TRᵢⱼ can comprise a weighted combination of the TRⱼ, and one or more weights of each TRᵢⱼ can depend on a reliability index of the rater i. The weight of TRᵢⱼ can also be at least partially dependent on a time factor, which can enable greater weight to be provided to more recent ratings. Additionally, let each Rᵢ for i=1, . . . , N represent the reliability index of a rater i.

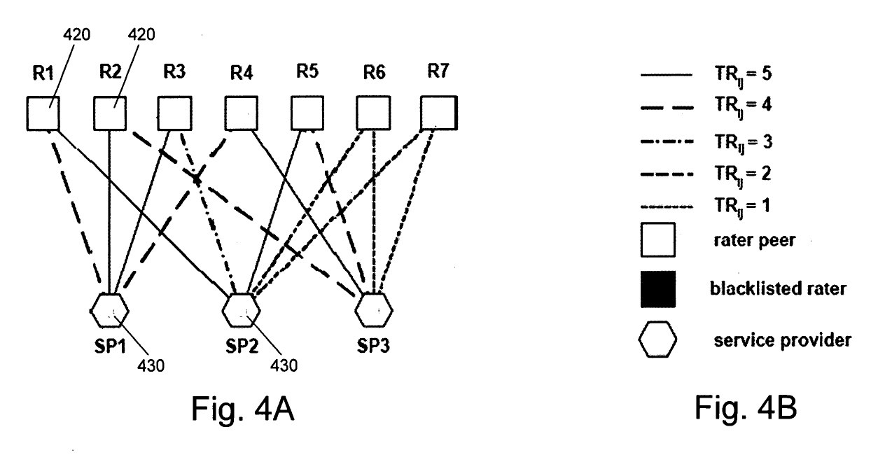

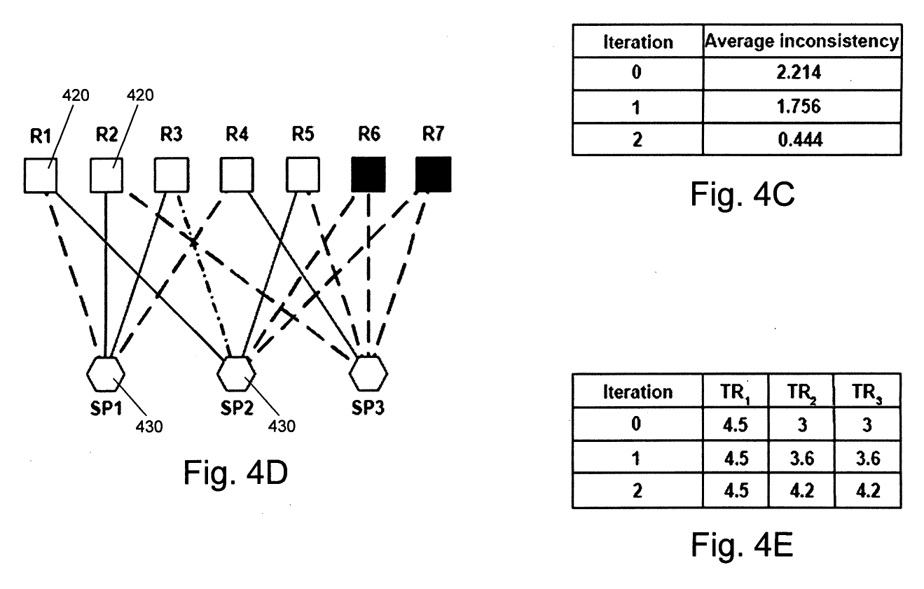

The iterative algorithm of the reputation tracking unit 160 can be based on graph-based iterative decoding of error-control codes, such as low-density parity-check codes in the presence of stopping sets. Accordingly, an example of raters, providers, and ratings of raters for providers are provided in FIG. 4A. In the graph of FIG. 4A, the square vertices, or check vertices 420, represent raters. The hexagonal vertices, or bit vertices 430, represent providers. In this example, the number of raters N is seven, and the number of providers k is three. An edge between a check vertex 420 of first rater and a bit vertex 430 of a first provider indicates that the first rater has provided a rating for the first provider. Thus, the graph has N check vertices 420 and k bit vertices 430. An edge between a check vertex 420 and a bit vertex 430 represents a rating TRᵢⱼ left by a rater i associated with the check vertex 420 for a provider j associated with the bit vertex 430. As shown in the table of FIG. 4B, each of five types of edges represents each of the five ratings from one to five. As shown in FIG. 4A, raters R6 and R7 are unreliable in that they consistently provide ratings of one in the one to five scale.

In our graph-based representation, Rᵢ represents a reliability index of rater i, and WRᵢⱼ=wᵢⱼ*TRᵢⱼ represents a time-factored value of the rating between rater i and provider j (i.e., the edge between the i^{th} check vertex 420 and the j^{th} bit vertex 430). Each wᵢⱼ(t) can be defined as λt-tᵢⱼ, where λ and tᵢⱼ respectively represented a fading parameter and a value of time passed since the corresponding rating TRᵢⱼ was initially provided. The parameter λ can be chosen to be less than one, thereby giving greater importance to more recent ratings. For the sake of simplicity, suppose each wᵢ is equal to one, and all Rᵢ are equal to one another.

At an iterative step of the reputation algorithm, let TR^{ν}ⱼ and TR^{ν}ᵢⱼ represent, respectively, current values of the total reputation index and the rating of rater i for provider j. Prior to the first iteration, ν, which can represent the current iterative step of the algorithm, can be set to zero. At the beginning of each iterative step, each TR^{ν}ᵢⱼ, which can represent the best guess as to the actual TRᵢⱼ, can be set to the TR^{ν-1}ᵢⱼ resulting from the previous iteration. An initial value of TR^{ν}ᵢⱼ can be a weighted combination of the ratings for provider i, where the weights are equivalent to a time-factor for each rating. In other words, the initial value of TR^{ν=0}ᵢⱼ can be the sum of all WRᵢⱼ. At each iteration, the following can be computed:

$${TR}_{j}^{v} = \frac{{\sum }_{i ∈ A} {R}_{i} {WR}_{ij}^{v}}{{\sum }_{i ∈ A} {R}_{i} {w}_{ij} ( t )}$$

where A is the set of raters (i.e., check vertices 420) having left a rating for provider j (i.e., bit vertex j 530).

During each iteration, an inconsistency factor C^{ν}ᵢ can be calculated for each rater i. Such calculation can comprise Cᵢ^{ν}=Σ_{j∈β} d(TRᵢⱼ^{ν-1}, TRⱼ^{ν-1}), where B is the set of raters (i.e., bit vertices 430) connected to the provider (i.e., bit vertex 430) j, and d(X,Y) is a predetermined distance metric for a distance between variables X and Y. In an exemplary embodiment of the reputation tracking unit 160, d(X,Y) can be the squared Euclidean distance between X and Y. Such a choice of d(X,Y) can effectively penalizes raters with a large deviation from the opinion of the majority.

After computing the distance metric for every check vertex 420, the check vertices 420 can be ordered based on the values of the distance metric. Then, the check vertex b 420 with the highest distance metric value can be selected as the rater with the highest inconsistency. Such rater can be blacklisted. The rating of the blacklisted rater can be updated such that, TR^{ν}_{bj} becomes 4 if TR^{ν-1}_{bj} was equal to 1 or 2, and TR^{ν}_{bj} becomes 2 if TR^{ν-1}_{bj} was either 4 or 5. For future iterative steps of the algorithm, a check vertex 420 that has been blacklisted is no longer included in the inconsistency calculation. Accordingly, the rating of rater b remains unchanged for the remainder of the calculation after being blacklisted and updated. The updated value of TR^{ν}_{bj} can continue to be used in the remainder of the iterative steps in calculating TRⱼ.

Returning now to the current iterative step of the algorithm, after updating the rating associated with rater b, the values of the bit vertices 430 can be updated in accordance with the above formula for TR^{ν}ᵢⱼ. Such updating can complete the current iterative step of the reputation algorithm of the reputation tracking unit 160. Iterations can continue as long as the average inconsistency measure continues to decrease. The iterations can cease when the average inconsistency measure increases due to the iteration. The average inconsistency can be defined as the average of the inconsistency factors of all check vertices 420 (excluding the ones already placed in the black list). The average inconsistencies for all iterations through the algorithm in the present example are illustrated in FIG. 4C.

The resulting provider reputation indices TRⱼ after performance of the above algorithm are illustrated in the graph of FIG. 4D and the table of FIG. 4E. As illustrated by FIGS. 4D-4E, unreliable raters R6 and R7 have been blacklisted, and their ratings for the providers have been accordingly updated.

The reputation tracking unit 160 can, but need not, update reputation indices every time a new rating is received. Updating indices with receipt of every new rating can be computationally costly. Hence, TRⱼ and Rᵢ can be calculated and updated periodically upon receiving a total of, for example, τ new ratings. After collecting every τ new ratings, the iterative algorithm can be initiated to update reputation indices of providers. In an exemplary embodiment of the reputation tracking unit 160, blacklisted raters are reconsidered as un-blacklisted when the iterative algorithm is reinitialized. Such previously blacklisted raters, however, can retain their reliability indices Rᵢ, which may have decreased based on prior blacklisting.

The values of Rᵢ can be updated using the blacklisted check vertices 420. Initially, all Rᵢ values can be set to 0.5, where αᵢ=1 and βᵢ=1. Use of variables αᵢ and βᵢ are described further below. After every completion of the iterative algorithm for calculating one or more reputation indices, Rᵢ for each blacklisted rater i can be recalculated. More specifically, Rᵢ can be decreased by setting βᵢ(t+1)=λβᵢ(t)+1. Otherwise, if rater i was not blacklisted, Rᵢ can be increased by setting αᵢ(t+1)=λαᵢ(t)+1. The parameter λ can be the time-fading parameter, as discussed above, for updating the Rᵢ values. In using such a fading parameter, greater weight can be allotted to recent ratings than to older ratings.

Updating Rᵢ's using the “Beta” distribution described above can have disadvantage in that every rater initially has a reliability of Rᵢ=0.5. Accordingly, an existing unreliable rater with a low Rᵢ has an incentive to cancel his account and open a new account to increase his Rᵢ to 0.5. This problem can be solved by discounting a user's ratings until the user has provided a predetermined number of ratings to associate the user with a reliable reliability index Rᵢ.

Similar to handling of newcoming raters, newcoming providers can also be handled to ensure reliability of reputation indices. For example, and not limitation, a newcoming provider can be excluded from the iterative algorithm until a predetermined number of ratings for the newcoming provider have been received. As requesting users may hesitate to select a newcoming provider who does not yet have a reputation index, a mechanism can be provided to encourage requesting users to select newcoming providers. For example, newcoming providers can offer their services for free or for discounts. Pricing for newcomers can be provided by the information service system 100, or newcoming providers can set their own pricing.

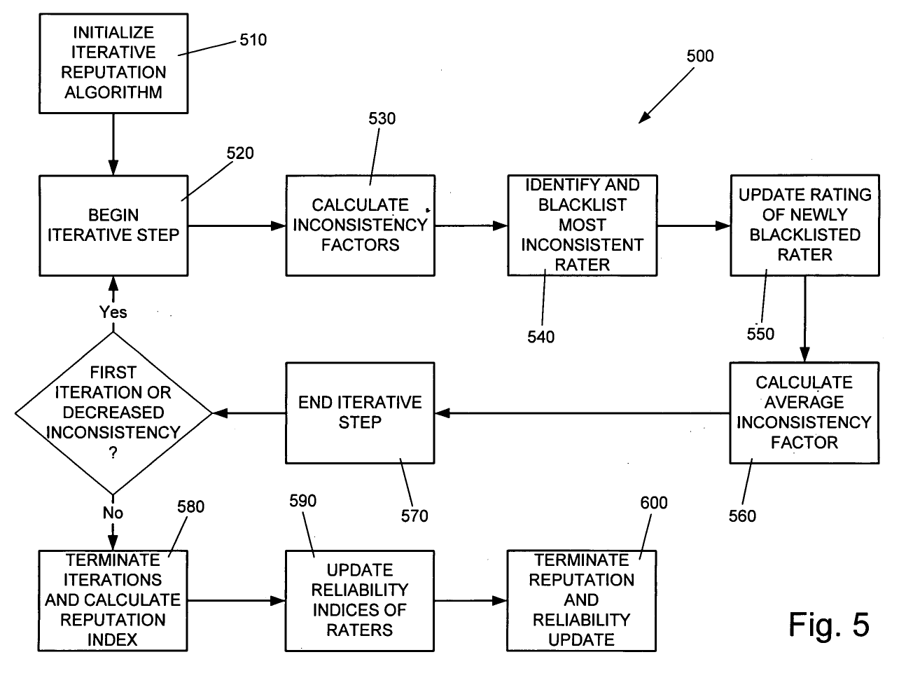

FIG. 5 illustrates an exemplary method 500 of performing updating providers' reputation indices and raters' reliability indices. At 510 of the method 500, the iterative reputation algorithm is initialized. The initialization step can comprise removing previously blacklisted peers from the blacklist, as well as initializing variables used in the algorithm. At 520, an iterative step of the algorithm begins. In the iterative step, at 530, an inconsistency factor is calculated for each rater. At 540, the rater with the highest inconsistency factor can be selected and blacklisted. The newly blacklisted rater's rating can then be updated at 550. At 560, an average inconsistency factor can be calculated based on the inconsistency factors calculated in 530. At 570, the iterative step ends. If the completed iterative step was the first iteration of the algorithm, or if the inconsistency factor decreased from the previous iteration, then the method 500 can return to 520 to perform an additional iteration of the algorithm. Otherwise, at 580, the iterations can terminate, and a final calculation of reputation indices can occur. At 590, the reliability indices of the raters can be updated based on which raters were blacklisted and which remained unblacklisted. At 600, the algorithm can terminate.

In an exemplary embodiment, all or multiple reputation indices are calculated in coordination, such that results of certain steps of the iterative algorithm can be shared amongst calculations for various reputation indices. For example, and not limitation, in a first iterative step, a given rater's inconsistency factor can be consistent across calculation of the reputation indices for every provider rated by the rater. Accordingly, calculating all such reputation indices in parallel can be more efficient than recalculating the inconsistency factor for individual, serial reputation index calculations.

Accordingly, as discussed above, the reputation tracking unit 160 can provide reliable ratings for providers, thereby enabling requesting users can make informed decisions in their selections of providers.

### III. Conclusion

As described above, the information service system 100 can provide an effective and reliable means for exchanging information in an online environment.

While the information service system 100 has been disclosed in exemplary forms, it will be apparent to those skilled in the art that many modifications, additions, and deletions may be made without departing from the spirit and scope of the system, method, and their equivalents, as set forth in the following claims.

1. A computer program product embodied in a computer-readable medium, the computer program product comprising an algorithm adapted to effectuate a method for providing an information service, the method comprising:
providing a pool of providers;
receiving a request from a requester for an information service;
identifying one or more of the providers as a provider subset available to perform the information service of the request;
presenting the requester with the provider subset;
presenting the requester with a reputation index for each of the providers in the provider subset;
receiving from the requester a selection of a first provider belonging to the provider subset; and
delivering the information service to the requester by transmitting data from the first provider to the requester in real-time.

2. The method of claim 1, the provider subset comprising one or more providers of pre-recorded information services.

3. The method of claim 1, the provider subset comprising one or more providers available for live provision of the information service.

4. The method of claim 1, further comprising receiving text-based feedback from the requester after completion of the information service.

5. The method of claim 1, further comprising:
receiving from the requester a rating of the first provider after completion of the information service; and
updating the reputation index of the first provider based on the rating received from the requestor.

6. The method of claim 5, wherein a value of the first provider's updated reputation index depends at least partially on a reliability index of the requestor.

7. The computer program product of claim 1, wherein identifying one or more of the providers as a provider subset comprises analyzing the request against one or more multimedia files associated with the pool of providers.

8. The method of claim 1, further comprising presenting the requester with a user interface for receiving the request, the user interface configured to present the provider subset to the requester and display the data transmitted from the provider to the requestor.

9. The method of claim 1, further comprising identifying the requester as a provider in a second provider subset for a second information service initiated by another requestor.

10. A system for providing information services, the system comprising:
a first computing device associated with a requester;
a server in communication with the first computing device, the server configured to receive a request for an information service from the requester, respond to the information service request by presenting the requester with a set a of potential providers, present the requester with a reputation index for each of the potential providers, and receive from the requester a selection of a provider belonging to the set of potential providers; and
a second computing device associated with the selected provider, the second computing device being in communication with the server and configured to perform the information service by transmitting data to the first computing device in real-time.

11. The system of claim 10, the request from the requester specifying a communication medium for the information service.

12. The system of claim 10, the request from the requester specifying a geographic area.

13. The system of claim 10, the server being distributed across two or more computing devices.

14. The system of claim 10, the second computing device further configured to transmit data to a plurality of other computing devices in real-time.

15. A computer program product embodied in a computer-readable medium, the computer program product comprising an algorithm adapted to effectuate a method for providing a free marketplace for information services, the method comprising:
providing a plurality of providers;
receiving from the plurality of providers a plurality of offers to sell a first information service, each of the plurality of offers being associated with a reputation index of a corresponding provider and a price set by the corresponding provider;
displaying the plurality of offers to a requesting user;
receiving from the requesting user a selection of a first provider of the plurality of providers;
transmitting data between the first provider and the requesting user, wherein the transmitted data is the first information service; and
transferring a payment to the first provider for the transmitted data, the payment being equal to the price set by the first provider for the first information service.

16. The computer program product of claim 15, further comprising filtering the plurality of providers based on a price range indicated by the requesting user.

17. The computer program product of claim 15, further comprising presenting to the requesting user a pricing statistic summarizing the prices associated with the offers to sell the first information service.

18. The computer program product of claim 17, further comprising dynamically updating the pricing statistic based on one or more selection criteria received from the requesting user.

19. The computer program product of claim 15, further comprising storing in a database the data transmitted between the first provider and the requesting user.

20. The computer program product of claim 19, further comprising receiving a price from the first provider for provision of the stored data as a second information service.
